(19) United States
(12) Patent Application Publication
(10) Pub. No.: US 2026/0361525 A1
(43) Pub. Date: Nov. 12, 2026

(54) EDGE PRE-PROCESSING WITH FREE SPACE OPTICAL LASER DATA TRANSMISSION USING SECURED LI-FI HASH-CHAIN PACKETS

(71) Applicant: Bank of America Corporation, Charlotte, NC (US)

(72) Inventors: Pratap Dande, Saint Johns, FL (US); Sakshi Bakshi, New Delhi (IN); Lester Killian, Mooresville, NC (US); Prem Obhan, Frisco, TX (US); George Albero, Charlotte, NC (US); Patricia A. Medeiros, Barrington, RI (US); Naga Vamsi Krishna Akkapeddi, Charlotte, NC (US); Jairo E. Batres, Charlotte, NC (US)

(21) Appl. No.: 19/202,044

(22) Filed: May 8, 2025

(51) Int. Cl. H04L 9/08; H04L 9/00

(52) U.S. Cl. CPC H04L 9/0861; H04L 9/50

(57) ABSTRACT

Network-edge document validation and hybrid hash chain/optical encryption. The methods may include receiving an original document from a user. The methods may include digitally accessing, using the enterprise network edge device, a template corresponding to the type. The methods may include digitally extracting from the original document, metadata corresponding to a field of the template. The methods may include binarizing the metadata. The methods may include defining a key in the metadata. The methods may include defining a value in the metadata that corresponds to the key and a field in the template that is designated as a value. The methods may include hashing the key to produce an index at which to store the value in the hash chain. The methods may produce a light-intensity token corresponding to an element of the chain. The methods may include modulating an optical signal corresponding to the token onto a light beam.

### FIELD OF TECHNOLOGY

Aspects of the disclosure relate to edge processing, binary encryption and optical encryption for optical communication.

### BACKGROUND

Enterprises typically operate information networks that receive documentary information from users. Validation protocols are usually executed on a back end. When a user is required to provide supplemental input, information processing may be delayed and overhead inefficiencies and costs may be incurred. In the current state, once a document comes to the network, it may have to pass through several apps that perform tasks like image detection, data extraction, indexing and categorization.

There are situations where the document or image needs to be resent from the user because the document does not correlate with a preexisting record or document data is unreadable. This may delay the subsequent processes, indexing and categorization as well. Delays occurring during backend processing may be more disruptive and costly than delays occurring at the edge, under the user's control.

Delays may occur repeatedly and may require human intervention by enterprise associates.

It therefore would be desirable to reduce errors and the need for manual intervention performing image detection, data extraction, indexing, categorization closer the user, at the edge of the network.

It also would be desirable to provide, along with the edge validation, encrypted high-speed optical communication within the edge and between the edge and the enterprise backend.

### SUMMARY

Apparatus and methods for edge validation, encrypted high-speed optical communication within the edge and between the edge and the enterprise backend are provided.

The apparatus and methods may include network-edge document validation and hybrid hash chain/optical encryption.

The methods may include receiving, using an enterprise network edge device, an original document from a user. The document may include one or more of a business document, a legal document, a certificate, a license, a photograph, a video recording, an animation, an audio recording or any other suitable document.

The methods may include capturing, using the enterprise network edge device, an image of the original document and storing it in a digital file. The methods may include, using the enterprise network edge device, digitally identifying a type of the original document.

The methods may include digitally accessing, using the enterprise network edge device, a template corresponding to the type.

The template may include fields. When virtually aligned with the document, the fields may map to data in the document. When an element of data is extracted from the document, the element becomes “metadata” that may be associated with one or more attributes of the field. A field may be predetermined to be a “key field.” This means that the metadata corresponding to the field will be treated as a key. The field may be predetermined to be a “value field.” This means that the metadata corresponding to the value field will be treated as a value. The key and the value may be linked to each other as a key-value pair. The apparatus may hash the key to define an indexed slot in a hash chain in which to store the value. The key and value relationships may be defined in the template.

The methods may include digitally extracting, using the enterprise network edge device, from the original document, metadata corresponding to a field of the template.

The methods may include executing, using a microprocessor in the edge device, a validation script corresponding to the type on the metadata.

The methods may include outputting, using the enterprise network edge device, to the user, a validation failure message. The message may correspond to an output of a validation test performed by the device.

The methods may include receiving, by the device, supplemental input from the user;

The methods may include converting, by the device, the supplemental input to supplemental metadata.

The methods may include executing, using the microprocessor, the validation script on the supplemental metadata.

The methods may include recording the metadata as valid.

The methods may include binarizing the metadata. The metadata may be converted from hexadecimal, ASCII or any other suitable format to binary.

The methods may include defining, using the device, a key in the metadata. The key may correspond to a field in the template that is designated as a key.

The methods may include defining, using the device, a value in the metadata that corresponds to the key and a field in the template that is designated as a value.

One or more values may be combined with a key to produce a new key that may be paired to another value.

The methods may include hashing, using the enterprise network edge device, a key to produce an index at which to store the value in the hash chain.

The methods may include applying natural language processing, using the enterprise network edge device, to a chain in the hash chain to produce a light-intensity token corresponding to an element of the chain.

The methods may include forming from the light-intensity token, using the enterprise network edge device, a pseudo-optical signal.

The methods may include modulating an optical signal corresponding to the pseudo-optical signal onto a light beam.

The methods may include transmitting the light beam to a remote optical receiver.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus that may be used in accordance with the principles of the invention.

FIG. 2 shows illustrative apparatus that may be used in accordance with the principles of the invention.

FIG. 3 shows an illustrative system architecture that may be used in accordance with the principles of the invention.

FIG. 4 shows illustrative information that may be used in accordance with the principles of the invention.

FIG. 5 shows illustrative information that may be used in accordance with the principles of the invention.

FIG. 6 shows illustrative data processing that may be used in accordance with the principles of the invention.

FIG. 7 shows illustrative data processing that may be used in accordance with the principles of the invention.

FIG. 8 shows illustrative data processing that may be used in accordance with the principles of the invention.

FIG. 9 shows illustrative apparatus that may be used in accordance with the principles of the invention.

FIG. 10 shows steps of an illustrative process in accordance with the principles of the invention.

The leftmost digit (e.g., “L”) of a three-digit reference numeral (e.g., “LRR”), and the two leftmost digits (e.g., “LL”) of a four-digit reference numeral (e.g., “LLRR”), generally identify the initial figure in which a part is called-out.

### DETAILED DESCRIPTION

Apparatus and methods for network-edge document validation and hybrid hash chain/optical encryption are provided.

An enterprise may provide the apparatus to users to support their activities. The apparatus may include, for example, a printer, a scanner, a card readers, and the like. The apparatus may include data acquisition and processing hardware, firmware or software. The apparatus may provide optical communication devices, hardware, firmware or software. The data acquisition and processing hardware, firmware or software may extract data from a user document, validate the data and encode the data for optical transmission. The optical communication devices, hardware, firmware or software may transmit the encoded data as an optical signal.

The apparatus and methods may acquire data from the document, and validate the data at the user's location. The apparatus and methods may reduce the burden of processing at the enterprise's backend. This may reduce the need for manual intervention and saving operational costs.

The apparatus may be configured to perform document analysis and encryption. The apparatus may include an optical scanner. The optical scanner may be configured to receive an original document from a user. The optical scanner may be configured to capture an image of the original document. The optical scanner may be configured to store the image in a digital file. The optical scanner may be configured to be deployed at the edge of an enterprise network. The edge may be defined as a set of devices that (1) are directly accessible by a user that is a recipient of goods or services provided by the enterprise; and (2) are configured to exchange data with each other for processing or transmission.

The apparatus may include a microprocessor. The microprocessor may be deployed at an edge of an enterprise network. The microprocessor may be configured to identify a type of the original document.

The microprocessor may be configured to access a template corresponding to the type. The microprocessor may be configured to extract, from the original document, metadata corresponding to a field of the template. The microprocessor may be configured to execute a validation script, corresponding to the type, on the metadata. The microprocessor may be configured to output to the user a validation failure message. The microprocessor may be configured to receive supplemental input from the user. The microprocessor may be configured to convert the supplemental input to supplemental metadata. The microprocessor may be configured to execute the validation script on the supplemental metadata. The microprocessor may be configured to record the metadata as valid. The microprocessor may be configured to binarize the metadata. The microprocessor may be configured to define a key in the metadata. The microprocessor may be configured to define a value in the metadata that corresponds to the key. The microprocessor may be configured to hash the keys to store the value in a hash chain. The microprocessor may be configured to apply natural language processing to a chain in the hash chain to produce a light-intensity token corresponding to an element of the chain. The microprocessor may be configured to form from the light-intensity token a pseudo-optical signal. The microprocessor may be configured to modulate an optical signal corresponding to the pseudo-optical signal onto a light beam. The microprocessor may be configured to transmit the light beam to a remote optical receiver.

The microprocessor may be configured to concatenate the first light-intensity token with a second light-intensity token.

The methods may include receiving, using an enterprise network edge device, an original document from a user. The document may include one or more of a business document, a legal document, a certificate, a license, a photograph, a video recording, an animation, an audio recording or any other suitable document.

The methods may include capturing, using the enterprise network edge device, an image of the original document and storing it in a digital file. The methods may include, using the enterprise network edge device, digitally identifying a type of the original document. Table 1 lists illustrative original document types.

TABLE 1
Illustrative original document types.

| Illustrative type | Illustrative example |
|---|---|
| Business document | Financial report, spread sheet |
| Legal document | Articles of incorporation, |
| | contract, lease |
| Certificate | Professional or avocational |
| | certification |
| License | Driver's license |
| Photograph | Personal portrait, landscape, |
| | architectural, documentary |
| Video recording | News clip, vehicle condition |
| | report, testimony |
| Audio recording | Dictation, testimony, |
| | testimonial |
| | Any other suitable document type |

The methods may include digitally accessing, using the enterprise network edge device, a template corresponding to the type.

The methods may include digitally extracting, using the enterprise network edge device, from the original document, metadata corresponding to a field of the template.

The methods may include executing, using a microprocessor in the edge device, a validation script corresponding to the type on the metadata.

The methods may include outputting, using the enterprise network edge device, to the user, a validation failure message. The message may correspond to an output of a validation test performed by the device.

The methods may include receiving, by the device, supplemental input from the user;

The methods may include converting, by the device, the supplemental input to supplemental metadata.

The methods may include executing, using the microprocessor, the validation script on the supplemental metadata.

The methods may include recording the metadata as valid.

The methods may include binarizing the metadata. The metadata may be converted from hexadecimal, ASCII or any other suitable format to binary.

The methods may include defining, using the device, a key in the metadata. The key may correspond to a field in the template that is designated as a key.

The methods may include defining, using the device, a value in the metadata that corresponds to the key and a field in the template that is designated as a value.

Table 2 lists illustrative metadata fields that may be designated as a key or a value.

TABLE 2
Illustrative metadata fields that may be designated as a key or a value.
Illustrative key or value

Document No.
Watermark
Graphic
Entire document
Place of issuance
Date of Issuance
Date of Expiration
User name
User photograph
User signature
Title
Table of Contents
Chapter Name
Chapter
Paragraph
Sentence
Word
X words (X = 100, 1000 or any
other suitable number)
Hologram
Fingerprint
Voice sample
Iris pattern
Any other suitable key or value

One or more values may be combined with a key to produce a new key that may be paired to another value.

The methods may include hashing, using the enterprise network edge device, a key to produce an index at which to store the value in the hash chain. An algorithm for storing a value in the hash chain may include a procedure such as:
Hash (Key A)=index for storage of Value A.

The methods may include applying natural language processing, using the enterprise network edge device, to a chain in the hash chain to produce a light-intensity token corresponding to an element of the chain.

The methods may include forming from the light-intensity token, using the enterprise network edge device, a pseudo-optical signal.

The methods may include modulating an optical signal corresponding to the pseudo-optical signal onto a light beam.

The methods may include transmitting the light beam to a remote optical receiver.

The digitally accessing a template corresponding to the type may include feeding to a large language model a series of tokens, each corresponding to a portion of the file. The digitally accessing a template corresponding to the type may include receiving from the model a document type. The digitally accessing a template corresponding to the type may include receiving from the model the template.

The template may define the key. The template may define the value.

The validation script may be configured to identify metadata that does not correspond to information required by the field. The validation script may be configured to identify in the metadata an invalid data type. The validation script may be configured to identify in the metadata missing data. The validation script may be configured to identify in the metadata a date that is inconsistent with another data in the file. The validation script may be configured to identify in the file unreadable data.

The supplemental input may include a re-scan of the original document. The supplemental input may include input from a keypad on the device. The supplemental input may include a supporting document.

The supplemental input may include a user signature. The supplemental input may include a user voice recording. The element may include a bit. The element may include a binary word. The element may include a value in the chain. The element may include two or more values in the chain.

The light-intensity token may be a first light-intensity token. The forming may include concatenating the first light-intensity token with a second light-intensity token. The second light-intensity token may have one or more features or properties in common with the first light-intensity token.

A light-intensity token may include logical symbols configured to produce a lighting pattern that expresses values in the hash chain.

The combination of free space optical (“FSO”) laser transmission using blockchain based hashed binary packets may create a secure data communication channel through laser beams which cannot be otherwise decrypted. This may provide information security through wireless medium across the cloud using laser transmission.

The apparatus and methods may convert the metadata into binary format which is hashed with unique key identifiers for categorization and reference. These hashed doc-blocks are may then converted to light packets for laser transmission.

Hashing of binary metadata may be layered over a laser line extraction algorithm using the center of gravity approach. This provides for real time indexing of the hashed data and may ease information extraction easier on real time basis when the information is spread over multiple devices and cloud.

The apparatus may scan documents and identify the type of document and metadata and treat the metadata as a master or record copy. The metadata may be used to convert the document to hash chains using the master copy.

The hash chain algorithms may be hybrid in nature.

The apparatus and methods may combine hashing of metadata and converting the metadata into binary to create a hash chain in binary format. Thus, the metadata is first converted to binary format and then hashed in the binary format itself. For example, this process may follow the steps:
“Hash-code (ASCII/UNICODE (<parameter∥Parameter_n>))”, meaning, binary conversion happens first, and then
“ASCII/UNICODE (<parameter∥Parameter_n>)),” followed by hashing in binary format, per
“Hash-code (ASCII/UNICODE (<parameter∥Parameter_n>))”.

In this step, hashing algorithm may convert the binary data into tokens of light packets.

Meta-doc laser line indexing may create real time indexes in binary formatted hash chains. The laser line indexing may involve a ‘center of gravity’ (“CoG”) laser line algorithm, followed by NLP engine (which may be part of the CoG process) for processing the hash chain metadata packets. The binary data may be converted into light-intensity tokens, which may correspond to physical light packets.

The CoG method may use an algorithm that calculates the center of mass of an image object. Also known as “centroid of plane figures”, the CoG method may be used in conformance with the following equations:

$$\overline{X} = \frac{\sum ax}{\sum a} \qquad \overline{Y} = \frac{\sum ay}{\sum a}$$

The apparatus and methods may model symbolic representations of light packets and use an NLP engine to correlate hash chain elements to the symbolic representations of the light packets.

The apparatus and methods may transmit hash chain metadata packets via laser. This may be performed using one or more microcontrollers, to provide at least one transmitter and at least one receiver. The apparatus may include laser photodiodes for laser conversion and a laser multiplexer to optimize the wavelength for transmission or to transmit and receive using different wavelengths.

An FSO converter may convert electrical data signals into light pulses, enabling transmission through open space using a laser beam, allowing for wireless data transmission via free space or the atmosphere. The converter receives digital data, modulates it onto a laser beam (transmitter side), and then demodulates the received light signal back into electrical data (receiver side).

Li-Fi lasers in an FSO architecture may be integrated with IoT controllers and edge devices across the cloud. Data and processes may be monitored and shared across using a distributed application mesh across the cloud.

The combination of FSO laser transmission using blockchain based hashed binary packets may provide a secure data communication channel through laser beams which cannot be otherwise decrypted. This may provide information security through wireless medium across cloud using laser transmission. This may be achieved through converting the metadata into binary format which is hashed with unique key identifiers for categorization and reference. These hashed doc-blocks may then be converted to light packets for laser transmission.

Illustrative embodiments of apparatus and methods in accordance with the principles of the invention will now be described with reference to the accompanying drawings, which form a part hereof. It is to be understood that other embodiments may be utilized, and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

The apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

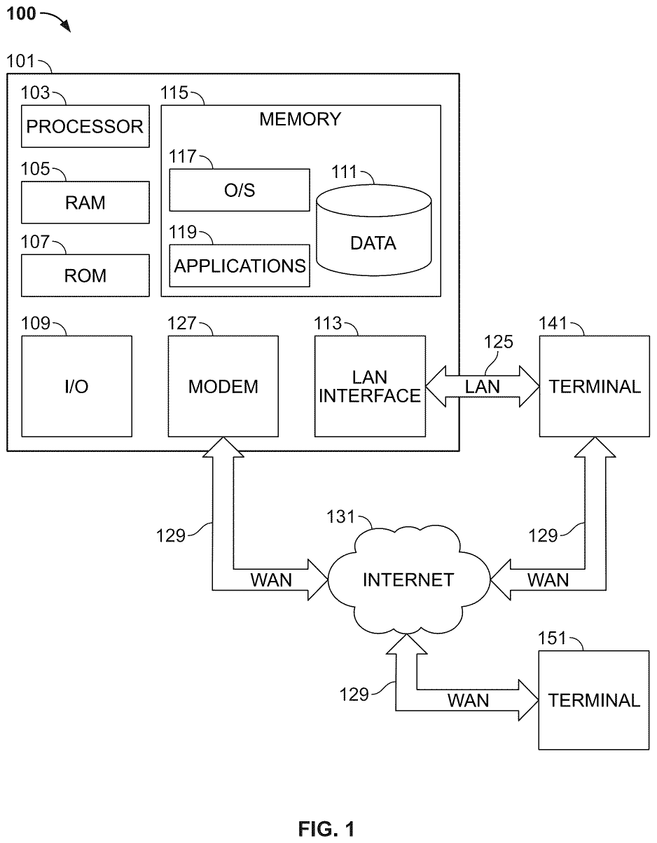

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smart phone, or any other suitable computing device. Elements of system 100, including computer 101, may be used to implement various aspects of the systems and methods disclosed herein. Each of the nodes, servers, computing devices, APIs, display monitors, databases and any other part of the disclosure may include some or all of apparatus included in system 100.

Computer 101 may have a processor 103 for controlling the operation of the device and its associated components and may include Random Access Memory (“RAM”) 105, Read Only Memory (“ROM”) 107, input/output circuit 109 and a non-transitory or non-volatile memory 115. Machine-readable memory may be configured to store information in machine-readable data structures. The processor 103 may also execute all software executing on the computer—e.g., the operating system and/or voice recognition software. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of the system 100. memory 115 may also store videos, text and/or audio assistance files. Nodes, servers, computing devices, models, APIs, display monitors, databases and any other suitable computing device as disclosed herein may have one or more features in common with memory 115. The data stored in memory 115 may also be stored in cache memory, or any other suitable memory.

Input/output (“I/O”) module 109 may include connectivity to a microphone, keyboard, touch screen, mouse and/or stylus through which input may be provided into computer 101. The input may include input relating to cursor movement or keyboard input. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. When used in a LAN networking environment, computer 101 is connected to LAN 125 through a LAN interface or adapter 113. When used in a Wide Area Network (“WAN”) networking environment, computer 101 may include a modem 127 or other means for establishing communications over WAN 129, such as Internet 131. Connections between System 100 and Terminals 151 and/or 141 may be used for the communication between different nodes and systems within the disclosure.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (“SMS”) and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may utilize one or more decisioning processes.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 111 and any other suitable information, may be stored in memory 115. One or more of applications 119 may include one or more algorithms that may be used to implement features of the disclosure comprising the transmission, storage, and transmitting of data and/or any other tasks described herein.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, tablet, smartphone, or any other computing system for receiving, storing, transmitting and/or displaying relevant information. Terminal 151 and/or terminal 141 may be one or more data sources or a calling source. Terminals 151 and 141 may have one or more features in common with apparatus 101. Terminals 115 and 141 may be identical to system 100 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

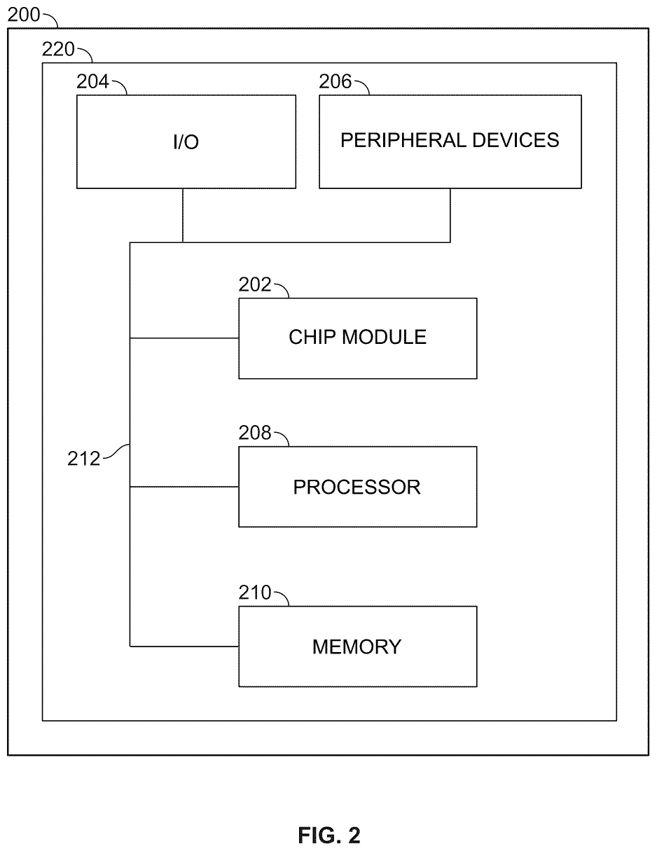

FIG. 2 shows illustrative apparatus 200 that may be configured in accordance with the principles of the disclosure. Apparatus 200 may be a computing device. Apparatus 200 may include one or more features of the apparatus shown in FIG. 2000. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

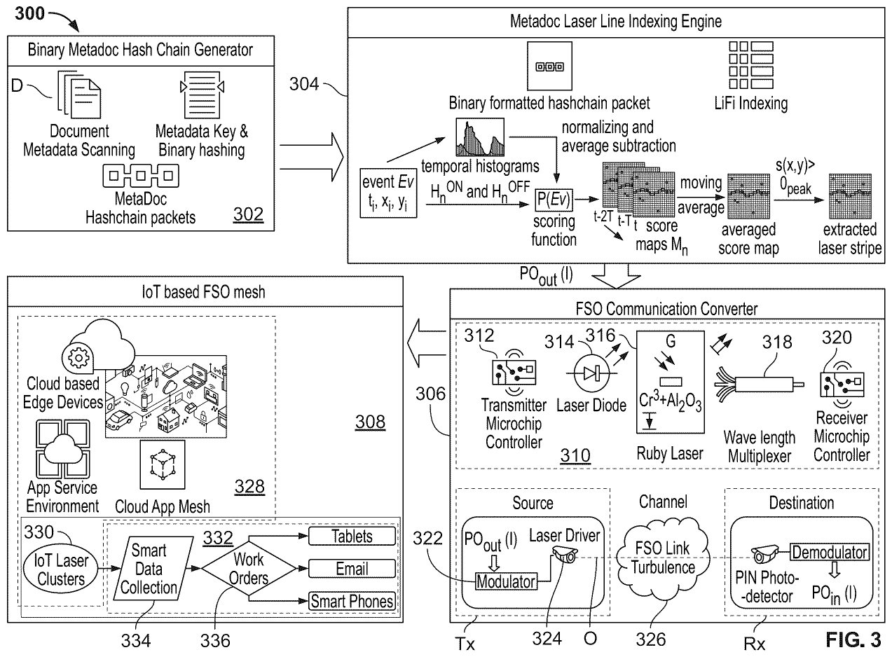

FIG. 3 shows illustrative architecture 300 for network-edge document validation and hybrid hash chain/optical encryption. Architecture 300 may include binary metadoc hash chain generator 302. Architecture 300 may include metadoc laser line indexing engine 304. Architecture 300 may include free-space optical communication converter 306. Architecture 300 may include Internet of Things (“IoT”)-based FSO mesh 308.

Binary metadoc hash chain generator 302 may reside in an enterprise network-edge device that is accessible by, and may be stationed at a location of, a user (not shown). Generator 302 may receive document D from a user (not shown). Generator 302 may optically scan document D. Generator 302 may extract predefined information from document D. The predefined information may be defined in a template corresponding to document D. The extracted information may be considered metadata. Generator 302 may perform network-edge validation of the metadata. After validating the data in document D, generator 302 may define one or more quanta of metadata as a “key.” Generator 302 may define one or more quanta of metadata as a “value.” Each value may correspond to one or more of the keys.

Generator 302 may binarize the metadata. After binarization of the metadata, generator 302 may hash the keys to store the corresponding values in a hash chain. One or more hash chains may be defined as a hash chain packet.

Metadoc laser line indexing engine 304 may receive a hash chain packet from generator 302. A neurolinguistic processing (“NLP”) engine (not shown) may derive for each hash chain packet a series of light-intensity tokens in which the binary hash chain packet is encoded. The light intensity tokens may correspond to 3-dimensional (two horizontal dimensions and time) histograms of light intensity patterns that would be observed by laser-striping an object or a document. The NLP engine may be trained to predict the light-intensity tokens from the hash chain packets using laser strip data simulating hash chain packets. Engine 304 may concatenate the light-intensity tokens to produce pseudo-optical output signal PSₒᵤₜ (I).

FSO communication converter 306 may be part of an FSO transmitter/receiver link such as link 310. Link 310 may include transmitter microchip controller 312. Link 310 may include laser diode 314. Laser diode may be used to pump ruby laser 316, which may transmit an optical signal over a distance. Link 318 may include receiver microchip controller 318. An optical sensor (not shown) may receive the optical signal. Information encoded in different wavelengths may be multiplexed by multiplexer 318. Multiplexer 318 may route the different wavelengths to receiver microchip controller 320. A node on an FSO network may include one or more of source components: 312, 314 and 316 and one or more of destination components: the optical sensor, 318 and 320.

FSO communication converter 306 may include modulator 322. Modulator 322 may receive pseudo-optical output signal POₒᵤₜ (I). Modulator 322 in transmitter Tx may modulate optical signal O corresponding to pseudo-optical output signal POₒᵤₜ (I) onto a transmission light beam that is transmitted by a laser and laser driver 324 in transmitter Tx over channel 326 to optical receiver Rx that is at a distance from FSO communication converter 306. Receiver Rx may demodulate the optical signal into pseudo-optical input signal POᵢₙ (I).

IoT based FSO mesh 308 may include two or more devices that include transmitters like transmitter Tx and receivers like receiver Rx. Mesh 308 may provide links by which POₒᵤₜ (I) can be broadcast to a large number of processors for distributing processing tasks related to document D. Mesh 308 may provide links by which POₒᵤₜ (I) can be transmitted to an enterprise backend network for substantive business, financial and legal processing and decision-making.

Mesh 308 may include IoT laser clusters 330. IT laser clusters 330 may provide high volume data transfer to smart data collection engine 334. Smart data collection 334 may parse the high volume data into different work types. Smart data collection engine 334 may feed the parsed data to work order engine 336, which may distribute work orders to appropriate enterprise personnel who receive the work orders on tables, via email and on smart phones.

Mesh 308 may be used to process a workflow such as workflow 330.

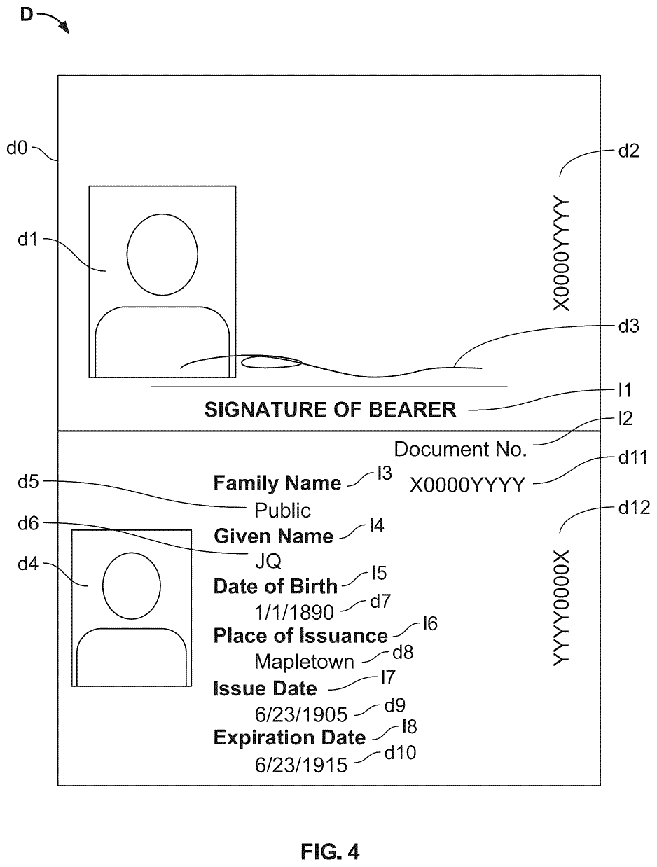

FIG. 4 shows illustrative document D. Document D may include data items dₚ. Table 3 lists data items dₚ. Document D may be associated with a document type.

TABLE 3
Data items dₚ.

| p | dₚ |
|---|---|
| 0 | Document |
| 1 | Photograph |
| 2 | Watermark |
| 3 | Signature |
| 4 | Photograph |
| 5 | Name |
| 6 | Name |
| 7 | Date |
| 8 | Place |
| 9 | Date |
| 10 | Date |
| 11 | Document |
| | Number |
| 12 | Watermark |

Document D may include data labels l_{q}. Table 4 lists data labels d_{q}.

TABLE 3
Data items lq.

| q | l_{q} |
|---|---|
| 1 | “SIGNATURE OF BEARER” |
| 2 | “DOCUMENT NO.” |
| 3 | “FAMILY NAME” |
| 4 | “GIVEN NAME” |
| 5 | “DATE OF BIRTH” |
| 6 | “PLACE OF |
| | ISSUANCE” |
| 7 | “ISSUE DATE” |
| 8 | “EXPIRATION DATE” |

Data items dₚ may be extracted as metadata.

Data labels dₚ may be extracted as metadata.

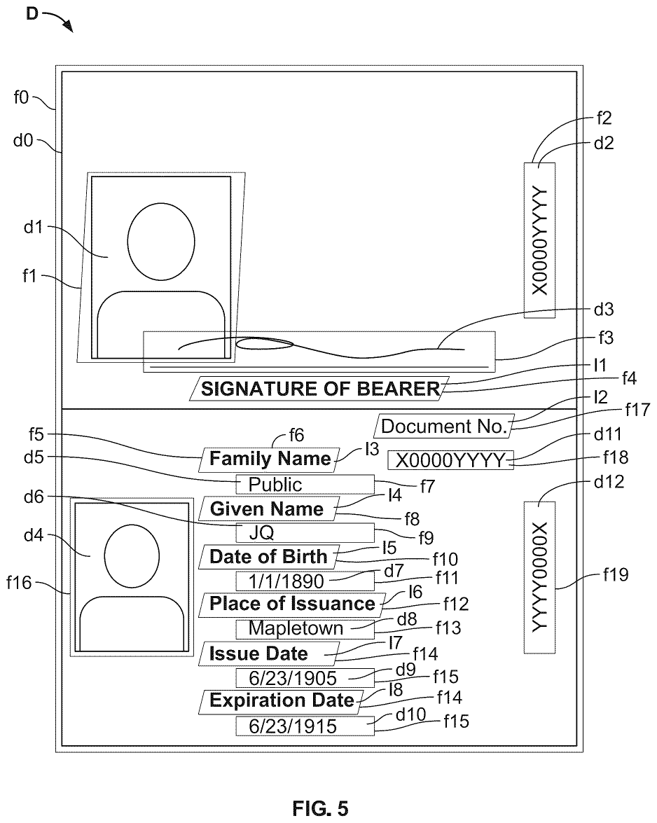

FIG. 5 shows document D with an overlay of template fields fᵣ. A field fᵣ may correspond to a data item dₚ. A field fᵣ may correspond to a data label l_{q}.

A field fᵣ may designate a data item dₚ or a data label l_{q} as a key (shown as parallelogram). A field fᵣ may designate a data item do or a data label l_{q} as a value (shown as a rectangle).

Any key may be paired to any value in a template profile that is determined by the enterprise for the document type or for all documents of a given class.

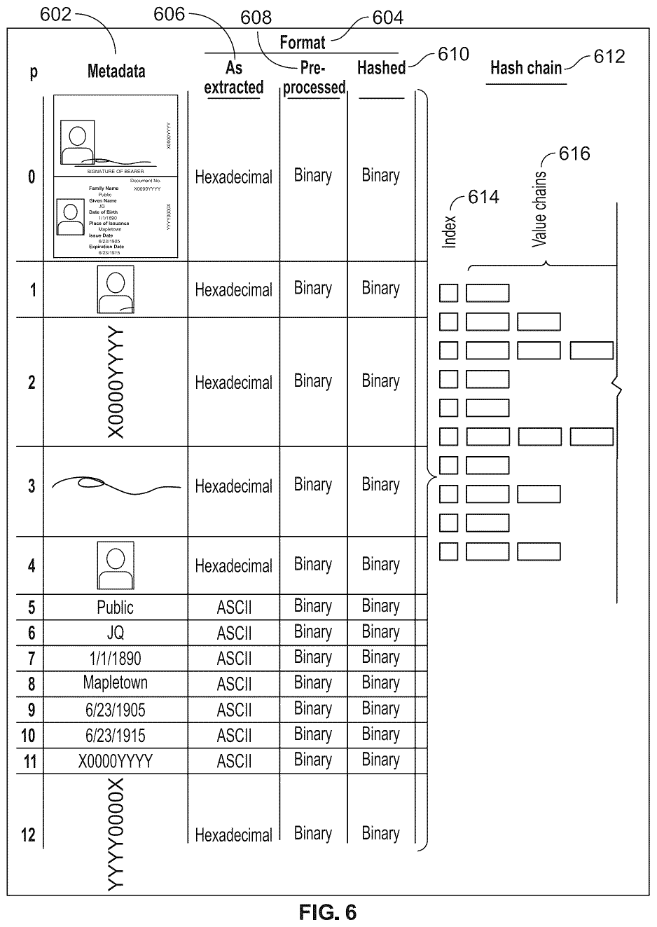

FIG. 6 shows metadata 602 extracted from document D for each data item dₚ. Illustrative formats 604 are shown for each metadata item at three stages of processing: As extracted stage 606, pre-processed stage 608 and hashed stage 610. Pre-processed stage 608 converts any extracted stage 606 data from its as-extracted format to binary prior to storage of the metadata in hash chain 612.

Hash chain 612 may include index 614. Hash chain 612 may include value chains 616. A key from document d may be hashed. The corresponding value may be located in hash chain 612 in a chain determined by a hashing of the key.

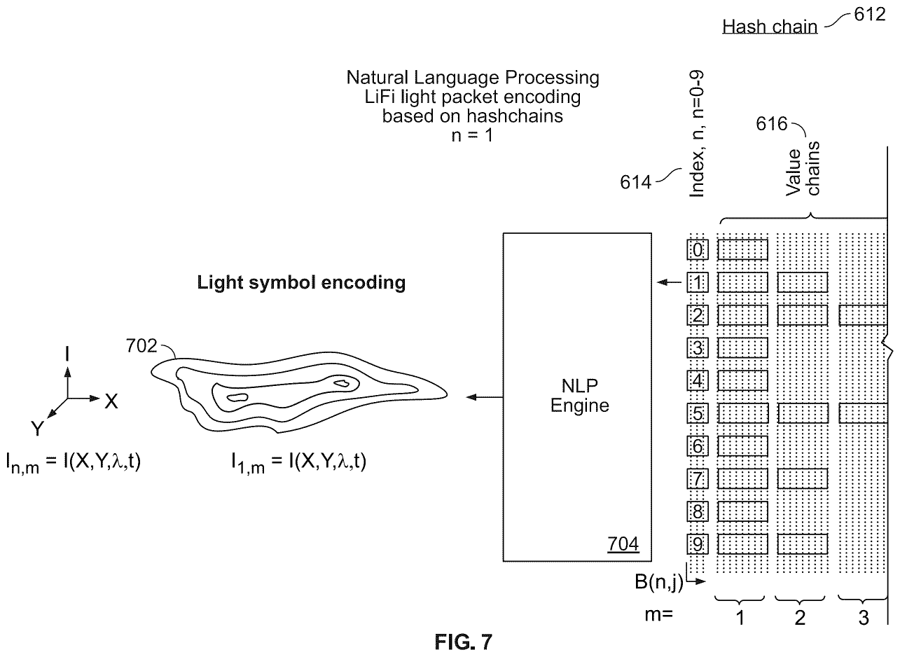

FIG. 7 shows schematically illustrative intensity map 702. Intensity map 702 may be represented generally as I_{n,m}=I(X, Y, l, t), wherein I is light intensity in an optical communication beam, X and Y are orthogonal axes normal to the direction of propagation of the beam, l is wavelength, and t is time. n corresponds to index 614. m corresponds to a position in value chains 616. Thus, I_{n,m} is an encoded segment of hash chain 612 for later modulation as an optical signal having an intensity that may vary across the beam, with wavelength and with time. I_{n,m} may be considered a symbolic representation of a Li-Fi light packet that corresponds to a segment of value chain 616. The segment may be represented as B (n, j_{start,end}). j_{start,end} indicates the part of a value chain 616 that may be included in I_{n,m}. j may increment with bits, bytes, data words, value fields (identified as m=1, 2, 3 . . . ), and entire value chain or any other suitable value.

NLP engine 704 may operate on the segment to create I_{n,m}.

Intensity map 702 corresponds to n=1.

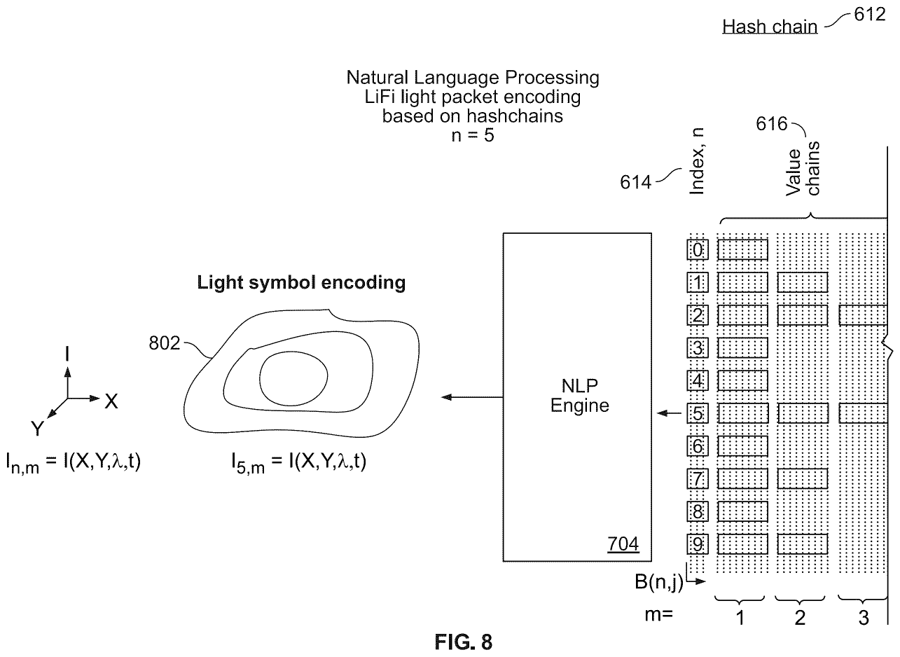

FIG. 8 shows schematically illustrative intensity map 802. Intensity map 802 may correspond to the symbolic representation I_{5,m}.

A pseudo-optical output signal POₒᵤₜ (I) may be constructed as a sequence such as:

POₒᵤₜ(I)=I_{n=0,m=0 . . . M},I_{n=1,m=0 . . . M}, . . . ,I_{n=N,m=0 . . . . M}.

POₒᵤₜ (I) may be converted to optical signal O (FIG. 3) for transmission to a remote receiver.

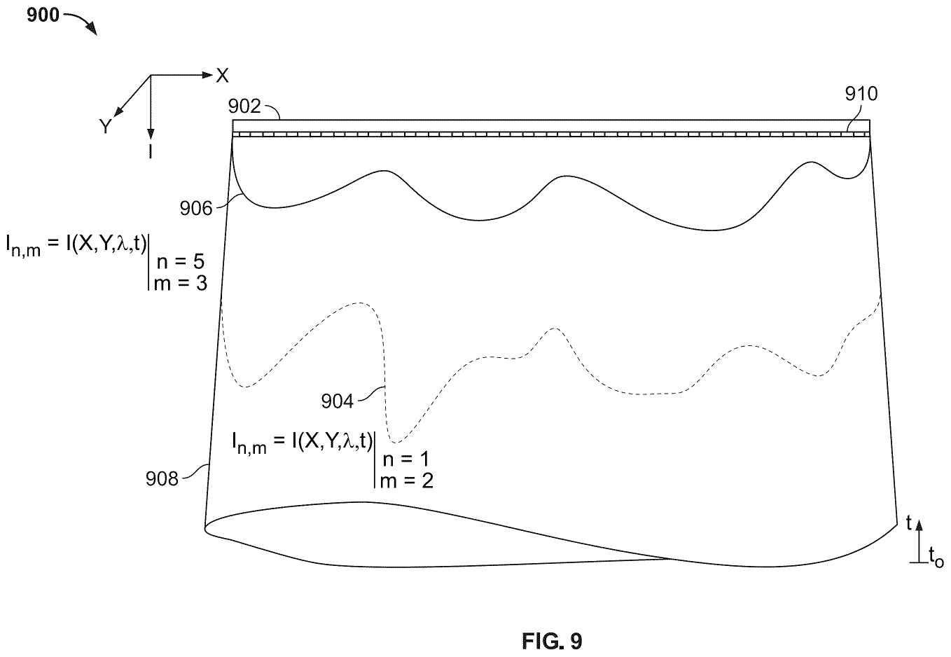

FIG. 9 shows illustrative schema 900. In schema 900, light source 902 may emit light beam 908 onto which has been modulated, at different times, optical signals 904 and 906, corresponding, for example, to I_{1,2} and I_{5,3}, respectively. Optical signals 904 and 906 may vary with location in the beam, wavelength and time.

Light source 902 may include array 910 of individually controllable emitters that may be used to modulate optical signals O onto beam 908.

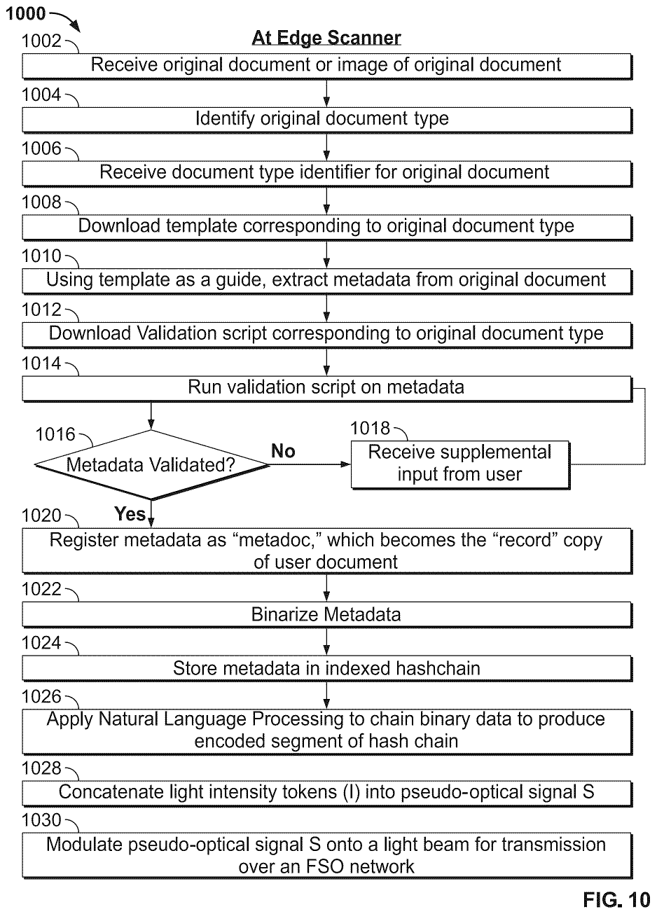

FIG. 10 shows illustrative steps of process 1000 for network-edge document validation and hybrid hash chain/optical encryption are provided.

Process 1000 may begin at step 1002. At step 1002, the system may receive an original document or an image of an original document. At step 1004, the system may identify a type of the original document. At step 1006, the system may receive a document type identifier for the original document. At step 1008, the system may download a template corresponding to original document type. At step 1010, the system may, using the template as a guide, extract metadata from original document. At step 1012, the system may download a validation script corresponding to original document type. At step 1014, the system may run a validation script on the metadata. At step 1016, the system may determine whether the metadata is valid.

If at step 1016, the system determines that the metadata is not valid, process 1000 may continue at step 1018. At step 1018, the system may prompt for and receive from a user supplemental input. The system may then proceed to step 1014 to rerun the validation script using the supplemental input.

When, at step 1016, the metadata is found to be valid, process 1000 may continue to step 1020. At step 1020, the system may register meta data as “metadoc,” which becomes the “record” copy of user document. At step 1022, the system may binarize the metadata. At step 1024, the system may store the metadata in an indexed hash chain. At step 1026, the system may apply natural language processing to the hash chain binary data to produce an encoded segment of hash chain that represents an optical signal. At step 1028, the system may concatenate encoded segments of the hash chain to produce a pseudo-optical output signal. At step 1030, the system may modulate the pseudo-optical output signal onto a light beam for transmission over a free space optical network.

Thus, apparatus and methods for network-edge document validation and hybrid hash chain/optical encryption are provided are provided. Persons skilled in the art will appreciate that the present invention can be practiced by other than the described embodiments, which are presented for purposes of illustration rather than of limitation.

What is claimed is:

1. Apparatus for document analysis and encryption, the apparatus comprising:
an optical scanner that is configured to:
receive an original document from a user; and
capture an image of the original document in a digital file;
a microprocessor that is:
deployed at an edge of an enterprise network; and is configured to:
identify a type of the original document;
access a template corresponding to the type;
extract, from the original document, metadata corresponding to a field of the template;
execute a validation script, corresponding to the type, on the metadata;
output to the user a validation failure message;
receive supplemental input from the user;
convert the supplemental input to supplemental metadata;
execute the validation script on the supplemental metadata;
record the metadata as valid;
binarize the metadata;
define a key in the metadata;
define a value in the metadata that corresponds to the key;
hash the keys to store the value in a hash chain;
apply natural language processing to a chain in the hash chain to produce a light-intensity token corresponding to an element of the chain;
form from the light-intensity token a pseudo-optical signal;
modulate an optical signal corresponding to the pseudo-optical signal onto a light beam; and
transmit the light beam to a remote optical receiver.

2. The apparatus of claim 1 wherein the supplemental input includes a supporting document.

3. The apparatus of claim 1 wherein the supplemental input includes a user signature.

4. The apparatus of claim 1 wherein the supplemental input includes a user voice recording.

5. The apparatus of claim 1 wherein the element includes a bit.

6. The apparatus of claim 5 wherein the element includes a binary word.

7. The apparatus of claim 5 wherein the element includes a value in the chain.

8. The apparatus of claim 7 wherein the element includes two values in the chain.

9. The apparatus of claim 1 wherein:
the light-intensity token is a first light-intensity token; and
the microprocessor is further configured to concatenate the first light-intensity token with a second light-intensity token.

10. The apparatus of claim 1 wherein the light-intensity token includes logical symbols configured to produce a lighting pattern that expresses values in the hash chain.

11. A method for network-edge document validation, the method comprising:
using an enterprise network edge device:
receiving an original document from a user;
capturing an image of the original document in a digital file;
digitally identifying a type of the original document;
digitally accessing a template corresponding to the type;
digitally extracting, from the original document, metadata corresponding to a field of the template;
executing, using a microprocessor in the edge device, a validation script corresponding to the type on the metadata;
outputting to the user a validation failure message;
receiving supplemental input from the user;
converting the supplemental input to supplemental metadata;
executing, using the microprocessor, the validation script on the supplemental metadata;
recording the metadata as valid;
binarizing the metadata;
defining a key in the metadata;
defining a value in the metadata that corresponds to the key;
hashing the keys to store the value in a hash chain;
applying natural language processing to a chain in the hash chain to produce a light-intensity token corresponding to an element of the chain;
forming from the light-intensity token a pseudo-optical signal;
modulating an optical signal corresponding to the pseudo-optical signal onto a light beam; and
transmitting the light beam to a remote optical receiver.

12. The method of claim 11 wherein the digitally accessing a template corresponding to the type comprises:
feeding to a large language model a series of tokens, each corresponding to a portion of the file; and
receiving from the model:
a document type; and
the template.

13. The method of claim 12 wherein the template defines the key and the value.

14. The method of claim 13 wherein the validation script is configured to identify metadata that does not correspond to information required by the field.

15. The method of claim 13 wherein the validation script is configured to identify in the metadata an invalid data type.

16. The method of claim 13 wherein the validation script is configured to identify in the metadata missing data.

17. The method of claim 13 wherein the validation script is configured to identify in the metadata a date that is inconsistent with another data in the file.

18. The method of claim 13 wherein the validation script is configured to identify in the file unreadable data.

19. The method of claim 11 wherein the supplemental input includes a rescan of the original document.

20. The method of claim 11 wherein the supplemental input includes input from a keypad on the device.
